(19) United States
(12) Patent Application Publication
(10) Pub. No.: US 2013/0300562 A1
(43) Pub. Date: Nov. 14, 2013

(54) GENERATING DELIVERY NOTIFICATION

(71) Applicants: Alexander Krasinskiy, Bad Schoenborn (DE); Lukas Stehr, Mannheim (DE); Ralf Schroth, St. Leon-Rot (DE); Renzo Colle, Stutensee (DE); Bjoern List, Neisse-Maixetal (DE)

(72) Inventors: Alexander Krasinskiy, Bad Schoenborn (DE); Lukas Stehr, Mannheim (DE); Ralf Schroth, St. Leon-Rot (DE); Renzo Colle, Stutensee (DE); Bjoern List, Neisse-Maixetal (DE)

(73) Assignee: SAP AG, Walldorf (DE)

(21) Appl. No.: 13/469,733

(22) Filed: May 11, 2012

(51) Int. Cl. G08B 21/00

(52) U.S. Cl. 340/540

(57) ABSTRACT

The present disclosure describes methods, systems, and computer program products for generating delivery notification records. A described technique includes (i) identifying a computer-readable text file associated with an inbound delivery notification at a first system, the first system associated with an enterprise resource planning (ERP) system (ii) identifying backend information associated with the identified text file from the ERP system, (iii) analyzing the identified text file using an information recognition method to identify a proposed set of information associated with the identified backend information based on the analysis, (iv) verifying at least a portion of the proposed set of information from the identified text file based on data associated with the ERP system and related to the identified backend information, and (v) associating at least a portion of the verified set of information from the identified text file with an instance of a delivery notification data object.

### TECHNICAL FIELD

The present disclosure relates to software, computer systems, and computer-implemented methods used to detect and extract useful information from printed or non-business-object information to generate a digital form of business document (e.g., a delivery notification) in an enterprise resource planning (ERP) system.

### BACKGROUND

Business transactions often involve buyers, sellers, and suppliers. The buyers can purchase from the sellers through on-site shopping, online transaction, and other business forms. A purchase can be processed by the seller by directly delivering in-stock items to the buyers or by having the suppliers to deliver items to the buyers via shipment. The delivery process generates a shipment delivery notification that can be sent to the buyers for shipment notification and confirmation. The buyer may track the shipped package before receiving the shipment and/or verify that the shipped product meets order requirements. The shipment delivery notification can be sent to the buyers from either the sellers or the suppliers.

### SUMMARY

The present disclosure describes methods, systems, and computer program products used to detect and extract useful information from printed or non-business-object information to generate a digital form of business document (e.g., delivery notification) in an enterprise resource planning (ERP) system. The delivery notification records can be automatically generated from printed document with adaptive pattern recognition to accurately extract information from the printed document into data objects. A described technique includes (i) identifying a computer-readable text file associated with an inbound delivery notification at a first system, the first system associated with an enterprise resource planning (ERP) system (ii) identifying backend information associated with the identified text file from the ERP system, (iii) analyzing the identified text file using an information recognition method to identify a proposed set of information associated with the identified backend information based on the analysis, (iv) verifying at least a portion of the proposed set of information from the identified text file based on data associated with the ERP system and related to the identified backend information, and (v) associating at least a portion of the verified set of information from the identified text file with an instance of a delivery notification data object.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a notification content generation system.

FIG. 2 is a flow chart illustrating a general process of analyzing and digitizing delivery notifications.

FIG. 3 is a flow chart illustrating a pattern recognition process used in analyzing and digitizing delivery notifications.

FIGS. 4A and 4B are flow charts illustrating, respectively, a high level and a low level purchase order identification process.

FIG. 5 is a flow chart illustrating a process for identifying key information in a delivery notification.

FIG. 6 is an example flow chart illustrating pattern recognition used in identifying key information.

FIG. 7 is a flow chart illustrating a process for identifying shipment date and delivery date.

FIG. 8 is a flow chart illustrating a process for identifying gross weight and volume of shipment.

FIGS. 9A and 9B are example flow charts illustrating different identification processes.

FIG. 10 is a flow chart illustrating an adaptation process.

FIGS. 11A-C show an example of delivery notification.

### DETAILED DESCRIPTION

This disclosure generally relates to software, computer systems, and computer-implemented methods used to detect and extract useful information from printed or non-business-object information to generate a digital form of business document (e.g. delivery notification) in an enterprise resource planning (ERP) system. The automation of generation process of business document is realized via a multi-level pattern recognition based on adaptation, context-based, and generic rule sets used for the data extraction, and further, can use a closed feedback loop from users to enhance recognition accuracy. The information detected and extracted to generate the business document can be confirmed and/or corrected by the user, so that the confirmation and correction operation can be used to improve a data recognition algorithm for more accurate detection and extraction in the future by updating and creating new adaptive context-based rules, which can be supported independently of the used document language. The present disclosure can facilitate the process of generating and completing a business document by example of shipment or delivery notification for customers (e.g., from suppliers to sellers and/or buyers) when an original printed document is not in digital form and/or is not in business data format.

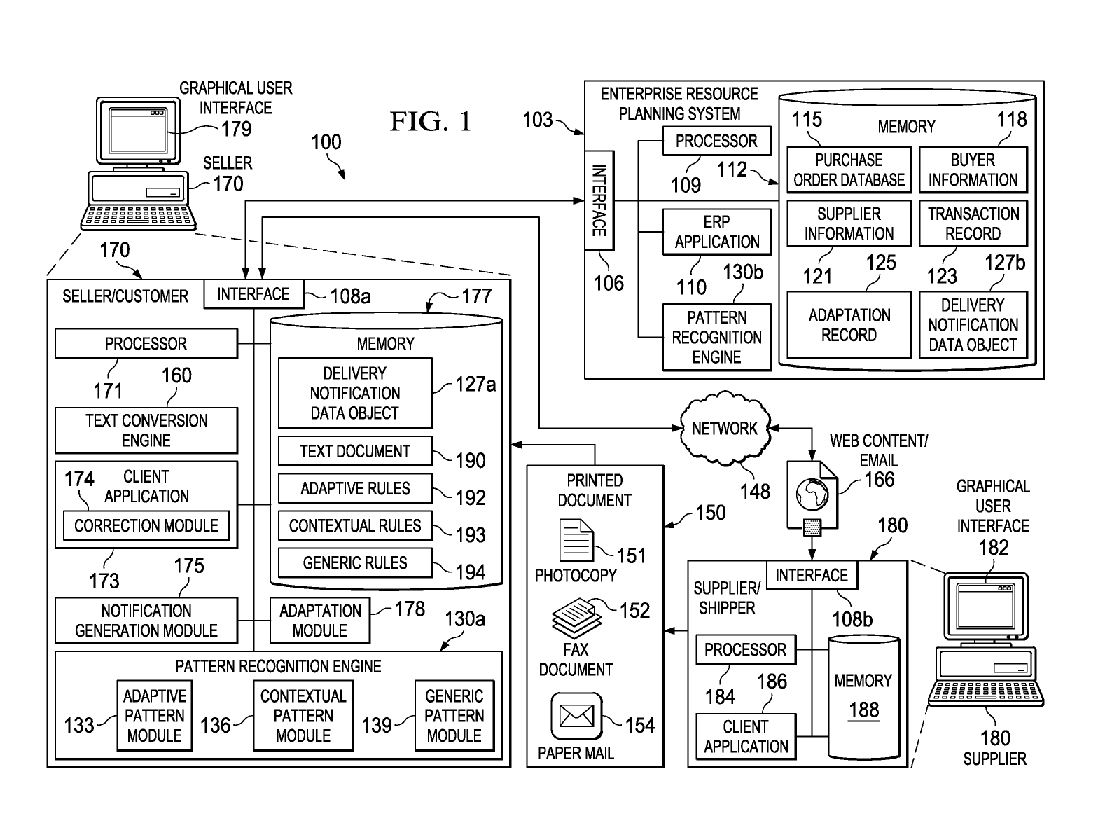

FIG. 1 illustrates an example environment 100 for implementing various features of a notification content generation system. The illustrated environment 100 includes, or is communicably coupled with, a supplier/shipper 180, a seller/customer 170, and an enterprise resource planning (ERP) system 103. At least some of the communications between the ERP system 103 and the seller/customer 170 may be performed across or via network 148. In general, environment 100 depicts an example configuration of a system for analyzing printed document 150 and generating a delivery notification within the computer system within the seller/customer 170 in conjunction with external backend systems, such as the ERP system 103. The environment 100 is an example, and in alternative implementations, the elements illustrated in FIG. 1 may be included in or associated with different and/or additional servers, clients, networks, and locations other than those as shown. For example, one or more of the components illustrated within the ERP system 103, the seller/customer 170, or any of the other illustrated components, may be located in multiple or different servers, cloud-based networks, or other locations accessible to the ERP system 103 (e.g., either directly or indirectly via network 148).

At a high level, the supplier/shipper 180, after receiving a purchase order (e.g., directly from a buyer or through a seller), can complete the order by shipping out products. In other implementations, instead of a purchase order, the document provided by the supplier/shipper 180 can be associated with another type of general document or set of documents recording or associated with a particular transaction, for example, a customer invoice, an outbound delivery or sales order, a stock transfer order, a service order, or a customer return, among others. These documents, including the purchase order, may be considered “predecessor documents,” such that they are related to some prior transaction and can be used, in some instances, to provide further context to a delivery notification. In some instances, no predecessor document may exist or be otherwise available. In either instance, information may be retrieved from a backend system to match master and other data associated with delivery notification or other correspondence. Returning to the illustrated example, this shipment generates a record for the recipients and associated parties that can be in various forms, for example, as web content 166 (e.g., an email, a HTML webpage, etc.), and printed document 150 (e.g., a photocopy 151, a fax document 152, paper mail 154, etc.). The seller/customer 170 receives the shipment record and converts any non-computer-readable format into a computer-readable text document (for example, using scanning and optical character recognition).

A pattern recognition algorithm then analyzes the computer-readable text document and finds the predecessor document (i.e., the purchase order) related to the shipment record, via the ERP system 103 or other appropriate backend system. The found purchase order can provide or be associated with a context and adaptation history that supplements the pattern recognition algorithm. However, the information of the purchase order or any predecessor document is not always necessary for the pattern recognition algorithm. For example, in some instances, there might not be a predecessor document, such as in case of receiving a service order, or a new shipment notice. In other instances, the information included in or associated with the predecessor document may be intentionally avoided, skipped, or otherwise not used for establishing new documents or pattern recognition rules, or to supplement the information determined during the text document analysis. Information related to a particular shipment notification format can then be extracted from the computer-readable text document using the pattern recognition algorithm and can be written into a delivery notification record, data object, or business object, to be saved by the seller/customer 170 and/or sent to the buyer.

As illustrated in FIG. 1, the seller/customer 170 includes a text conversion engine 160, a memory 177, a processor 171, a pattern recognition engine 130a, a client application 173, a notification generation module 175, an adaptation module 178, and an interface 108a. The seller/customer 170 receives the printed document 150, which may include one or more photocopies 151, fax documents 152, and paper mail 154, and converts the printed document 150 using the text conversion engine 160. The text conversion engine 160 can include a scanner and text recognition software such as an optical character recognition (OCR) program. The text conversion engine 160 scans the printed document 150 and generates a text string in a predetermined format that is saved in the memory 177 as the text document 190. The text document 190 can be read and used by other components within the seller/customer 170 as well as read and used by external systems such as the ERP system 103. For example, the text document 190 can be loaded by the client application 173, the adaptation module 178, and the pattern recognition engine 130a. Where the supplier/shipper 180 sends the information as web content or email 166 (via network 148), the text conversion engine 160 can ensure that the associated information is properly OCR'd in to a text document 190 prior to continuing the analysis.

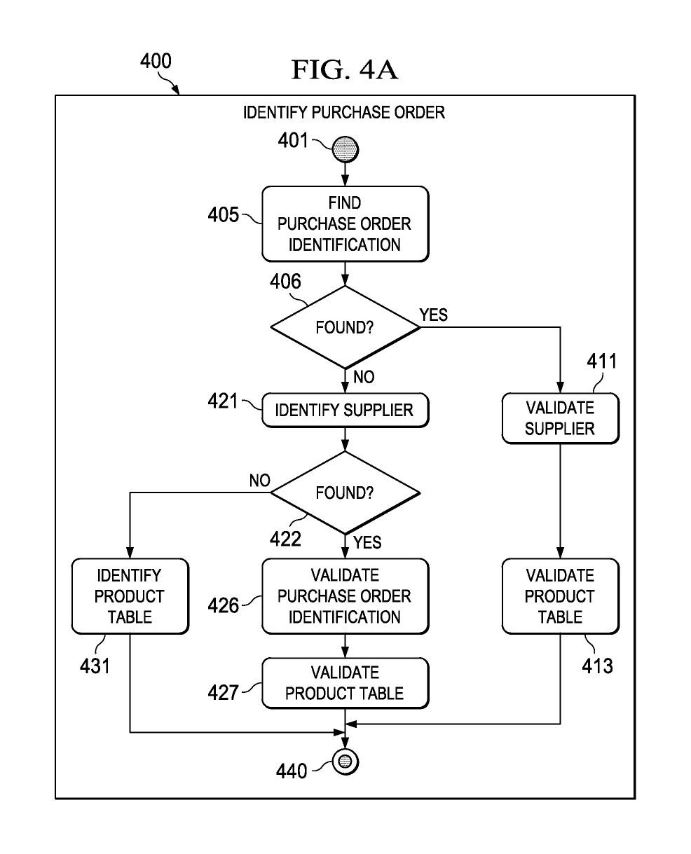

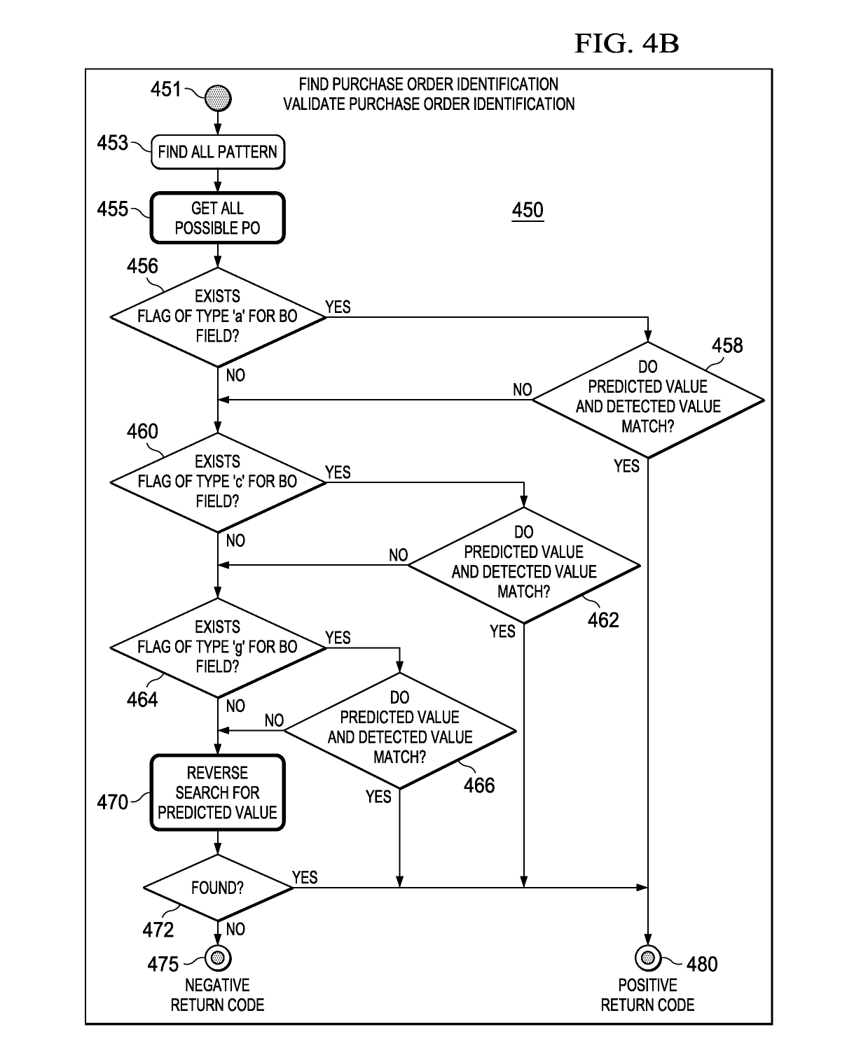

In some instances, the text document 190 can first be analyzed by the pattern recognition engine 130a to find a corresponding purchase order or other suitable predecessor document related to the printed document 150. Details of an example process for identifying the corresponding purchase order are described in FIGS. 4A and 4B. In general, the seller/customer 170 communicates with the ERP system 103 via interfaces 108a and 106 and accesses purchase order information from the purchase order database 115 in the memory 112 of the ERP system 103. In addition, the memory 112 of the ERP system 103 stores buyer information 118, supplier information 121, transaction record 123 and other information (for example, adaptation record 125) related to the purchase order. The ERP system 103 provides the information in the memory 112 to the seller/customer 170 such that the components in the seller/customer 170 can apply the information to the pattern recognition engine 130a. For example, the purchase order database 115 and the transaction record 123 in the memory 112 of the ERP system 103 can provide detailed data associated with a purchase order, including shipping address, product specifications, quantities, and other information, to the seller/customer 170 (with that information then optionally being stored at the memory 177), where adaptive rules 192 and generic rules 194 based on the purchase order can be loaded.

The memory 177 of the seller/customer 170 stores, in addition to the text document 190, data and program instructions, rules associated with pattern recognition engine 130a (e.g., adaptive rules 192 and generic rules 194), and delivery notification data 127a. The memory 177 may include any memory or database module and may take the form of volatile or non-volatile memory including, without limitation, magnetic media, optical media, random access memory (RAM), read-only memory (ROM), removable media, or any other suitable local or remote memory component. The memory 177 may store various objects, object models, and data, including classes, frameworks, applications, backup data, business objects, jobs, web pages, web page templates, database tables, process contexts, repositories storing services local to the seller/customer 170, and any other appropriate information including any parameters, variables, algorithms, instructions, rules, constraints, or references thereto associated with the seller/customer 170 and its functionality. In some implementations, including a cloud-based system, some or all of the memory 177 may be stored remote from the seller/customer 170, and communicably coupled to the seller/customer 170 for usage. Specifically, memory 177 can store various rules for the pattern recognition engine 130a, as well as the delivery notification data 127a to be output. Some or all of the elements illustrated within memory 177 may be stored external to the memory 177.

The processor 171 performs analysis and data extraction related to the text document 190 to create, populate, and modify the delivery notification data object 127a and 127b, based on the pattern recognition engine 130a and the modules therein. Although illustrated as a single processor 171 in the seller/customer 170, two or more processors may be used in the seller/customer 170 according to particular needs, desires, or particular embodiments of environment 100. The processor 171 may be a central processing unit (CPU), a blade, an application specific integrated circuit (ASIC), a field-programmable gate array (FPGA), or another suitable component. Generally, the processor 171 executes instructions and manipulates data to perform the operations of the seller/customer 170 and, specifically, the functionality associated with the corresponding application 110 and the pattern recognition engine 130b. In some general implementations, the text document 190 is associated with a purchase order located in the purchase order database 115 in the ERP system 103. The purchase order in the purchase order database 115 can be related to more information, such as the buyer information 118, the supplier information 121, the transaction record 123, the adaptation record 125, and delivery notification data object 127b. The associated information can be loaded to the memory 177 to form or to initiate adaptive rules 192 and generic rules 194.

In some implementations, for example, the supplier/shipper 180 can send a printed document 150 of a shipment notice to the seller 170. The shipment notice, or delivery notification, may correspond to a purchase order (i.e., related to an order placed) and/or a transaction record (i.e. credit or payment history, stock status, communication history, fulfillment information, etc.) stored in the memory 112 of the ERP system 103. The corresponding purchase order and transaction record can further define or relate to buyer information and supplier information for retrieving further data, for example, such as address (e.g., for identifying country, and the notation convention in the country), information format (e.g., relative position or order of arrangement of business data objects), and other suitable information. In the presence of adaptive pattern recognition, the corresponding purchase order can also be associated with further data in the adaptation record 125. The associated data can then be executed by the pattern recognition engine 130b in the ERP system 103 and/or loaded to the memory 177 of the seller 170. For example, the associated data can be used to find and/or identify adaptive rules 192 and generic rules 194 applicable to and/or associated with the purchase order corresponding to the shipment notice or transaction record sent from the supplier 180. These rules can then be used in the pattern recognition engine 130a for analyzing the text document 190 to extract information to create and/or populate the delivery notification data object 127a.

The example pattern recognition engine 130a includes three different pattern recognition modules: the adaptive pattern module 133, the contextual pattern module 136, and the generic pattern module 139. Other example pattern recognition engines 130a may include more, less, or alternative modules. The adaptive pattern module 133 can access, interpret, and apply the adaptive rules 192 in the memory 177. The adaptive rules 192 are generated when detected information is corrected or revised by the seller/customer, or user 170 (hereafter, “seller/customer”). For example, the pattern recognition engine 130a or 130b may first use the generic pattern module 139 or the contextual pattern module 136 to analyze and detect various entries and values from the text document 190, using that detected information to provide data to be written into the delivery notification data object 127a. Portions of the detected information may be presented to a user at the seller/customer via a modifiable table or page. The seller/customer 170 may then use the correction module 174 in the client application 173 to correct any mistaken or incorrect information in the presented set of information to be associated with the delivery notification data object 127a. The correction history can then be analyzed and saved by the adaptation module 178 into the adaptation record 125 so that the pattern recognition adopts the corrected pattern in future analyzes. For example, a contextual rule for determining a company associated with the delivery notification may be that the relevant information is located directly to the right of the term “Company.” Upon review, the user may change the automatically detected information (i.e., that was located to the right of “Company”) to information located below the term “Company.” The adaptation module 178 reviews the modification and determines from where in the text document 190 the updated information came. Once that determination is made, the adaptation module 178 can change the adaptation record to ensure that, in the future, data corresponding to “Company” is taken from below the “Company” term as opposed to the right of the term.

The contextual pattern module 136 can detect patterns based on the text string surrounding contexts. For example, a string of numerical characters with hyphen separators can indicate a phone number, while a string of numerical characters of a particular digit length can indicate an identification number, a zip code, a credit card number, etc. In some implementations, the contextual pattern module 136 can take prompters such as name, address, telephone numbers, etc. into consideration. For example, a shipping address and a billing address may be provided in separate entries or field, with the corresponding addresses detected beneath the corresponding phrases. The contextual pattern can also be based on the presentation arrangement of the content. For example, in some purchase orders, seller's address can be listed always before the buyer's address. According to this contextual pattern, if two addresses are detected, the former will be interpreted as the seller's address, while the latter the buyer's address. The contextual pattern module 136 can encompass different recognition criteria based on different fields and their properties. For example, the fields can include purchase order identification (ID), delivery notification ID, buying company, gross weight, gross volume, sender ID, and sender name, among others. The contextual pattern module may further enhance detection by identifying units of weight, currency, and other properties that can be predefined in contextual rules 193 in the memory 177, or from other predefined sources.

The generic pattern module 139 can detect patterns, for example, based on generic text string properties as defined by the generic rules 194. For example, if a text string matches a stored data object, such as a bank address, a buyer address, a seller address, tax information, date, currency, etc. the generic pattern module 139 can detect such pattern without reliance on adaptive pattern module 133 and the contextual pattern module 136. The generic pattern module 139 may also supplement the adaptive pattern module 133 and the contextual pattern module 136 in situations when the two modules 133 and 136 do not have specific rules for detection, for example, in cases of misplacement, truncation, spelling error, and other similar scenarios. In some instances, the generic rules 194 may define one or more baseline patterns to use where no adaptive rules 192 or contextual rules 193 are available. For example, the generic rules 194 may define a plurality of key words associated with delivery notifications, and assume that associated information is included directly to the right of those key words. When the key word is found, the generic pattern module 139 can assume the information to the right of those key words is to be used in the delivery notification data object 127a.

In some implementations, the adaptive pattern module 133, the contextual pattern module 136, and the generic pattern module 139 can operate in serial or in parallel with cross referencing verification with the information stored in both the memory 177 and the memory 112. In some implementations, for reducing operation delays, the pattern recognition engine 130a and 130b may respectively be available in both the seller/customer 170 and the ERP system 103 to realize efficient loading of information respectively from the memory 177 and the memory 112.

The client application 173 can enable the seller/customer 170 to load, review, and revise the data analyzed and detected by the pattern recognition engine 130a or 130b. In some implementations, the client application 173 can display the detected delivery notification data object 127a or 127b (or the contents thereof) derived from the text document 190, along with a scanned, photographic, or original version of the printed document 150, which can include a photocopy 151, a fax document 152, a paper mail 154, and others, or the web content/email 166. A user associated with the seller/customer 170 can then visually compare the detected data and the original information to verify the correctness of the detected data. For example, an OCR process may lead to spelling mistakes from the printed document 150 to the text document 190; while a detection algorithm may commit errors when information is arranged in a client-specific manner. When the detected information and the associated delivery notification document are provided together, the automatically detected information can be tested and reviewed, without requiring the user to perform the otherwise slow and tedious data entry process. The client application 173 includes a correction module 174 that allows the seller/customer 170 to make changes to the detected delivery notification data object 127a or 127b, thereby confirming or correcting the pattern recognition engine 130a or 130b.

Each correction made by the seller/customer 170 is monitored and recorded in the adaptation module 178, where new pattern recognition rules (adaptive rules 192) can be created or modified based on the correction. For example, the seller/customer 170 may find a detection error of mistaking a fax number for a telephone number based on the relative location of the number in the printed document 150. The adaptation module 178 records that correction and saves the correction as an adaptive rule 192 in the memory 177 for future recognition of the same pattern. Based on the types of recognition errors, the adaptive module 178 can also save correction patterns as contextual rules 193 or generic rules 194.

After verification by the seller/customer 170, the written delivery notification data object 127a or 127b can then be organized and generated into a formal delivery notification at the notification generation module 175. The notification generation module 175 can include different notification formats for various purposes. In some implementations, the notification format can be tailored to a particular buyer or a particular project. In some implementations, the notification generation module 175 can perform the writing action that associates at least a portion of the verified information from the text document 190 with the delivery notification data object 127a or 127b.

The GUI 179 associated with the seller/customer 170 includes a graphical user interface operable to, for example, allow the seller/customer 170 to interface with at least a portion of the client application 173, notification generation module 175, adaptation module 178, and/or their associated operations and functionality. Generally, the GUI 179 provides the particular user with an efficient and user-friendly presentation of business data provided by or communicated within the system. The GUI 179 may include a plurality of customizable frames or views having interactive fields, pull-down lists, and buttons operated by the user. For example, the GUI 179 may provide interactive elements that allow a user to interact with a particular component within and/or external to environment 100. Different portions of the corresponding component's functionality may be presented and accessible to the user through the GUI 179, such as through the client application 173 (e.g., a web browser). Generally, the GUI 179 may also provide general interactive elements that allow a user to access and utilize various services and functions of a particular component. In some instances, the client application 173 may be used to access various portions of the ERP system 103. In some instances, the client application 173 may be an agent or client-side version of the application 110 or other suitable component of the ERP system 103. The GUI 179 may present the information of the client application 173 for viewing and interaction. In general, the GUI 179 is often configurable, supports a combination of tables and graphs (bar, line, pie, status dials, etc.), and is able to build real-time portals, where tabs are delineated by key characteristics (e.g., site or micro-site). Therefore, the GUI 179 contemplates any suitable graphical user interface, such as a combination of a generic web browser, intelligent engine, and command line interface (CLI) that processes information in the platform and efficiently presents the results to the user visually.

Turning now to the ERP system 103, in general, the ERP system 103 is any server or system that stores, manages, and executes functionality associated with an ERP application 110 and the pattern recognition engine 130b. Additionally, the ERP system 103 may execute one or more ERP applications 110. For example, each ERP system 103 may be a Java® 2 Platform, Enterprise Edition (J2EE)-compliant application server that includes Java® technologies such as Enterprise JavaBeans® (EJB), J2EE Connector Architecture (JCA), Java® Messaging Service (JMS), Java® Naming and Directory Interface (JNDI), and Java® Database Connectivity (JDBC). In some instances, each ERP system 103 may store a plurality of various applications, while in other instances, the ERP system 103 may be a dedicated server meant to store and execute the pattern recognition engine 130b for a particular platform or application and its related functionality. In some instances, the ERP system 103 may include a web server or be communicably coupled with a web server, where one or more of the applications 110 associated with the ERP system 103 represent web-based (or web-accessible) applications accessed and executed through requests and interactions received on the seller/customer 170, executing a client application 173 operable to interact with the programmed tasks or one or more applications 110.

At a high level, the ERP system 103 includes an electronic computing device operable to receive, transmit, process, store, or manage data and information associated with the environment 100. The ERP system 103 illustrated in FIG. 1 can be responsible for receiving application-related requests from one or more sellers/customers 170 (as well as any other entity or system interacting with the ERP system 103, including desktop or mobile client systems), responding to the received requests by processing said requests in the associated application 110, and sending the appropriate responses from the appropriate component back to the requesting seller/customer 170 or other requesting system. Components of the ERP system 103 can also process and respond to local requests from a user locally accessing the server 103. Accordingly, in addition to requests from the seller/customer 170 illustrated in FIG. 1, requests associated with a particular component may also be sent from internal users, external or third-party customers, and other associated business applications, business processes, as well as any other appropriate entities, individuals, systems, or computers. In some instances, the application 110 or the client application 173 may be web-based applications executing functionality associated with a networked or cloud-based business process.

As used in this present disclosure, the term “computer” is intended to encompass any suitable processing device. For example, although FIG. 1 illustrates a single ERP system 103, environment 100 can be implemented using any number of servers, as well as computers other than servers, including a server pool. Indeed, the ERP system 103 may be any computer or processing device such as, for example, a blade server, general-purpose personal computer (PC), Macintosh®, workstation, UNIX-based workstation, or any other suitable device. In other words, the present disclosure contemplates computers other than general purpose computers, as well as computers without conventional operating systems. Further, the illustrated ERP system 103 may be adapted to execute any operating system, including Linux, UNIX, Windows®, Mac® OS, iOS, or any other suitable operating system.

In the illustrated implementation of FIG. 1, the ERP system 103 includes an interface 106, a processor 109, a memory 112, an ERP application 110, and a pattern recognition engine 130b. In some instances, the ERP system 103 and its illustrated components may be separated into multiple components executing at different servers and/or systems. For example, while FIG. 1 illustrates the application 110 and the pattern recognition engine 130b as separate components, other example implementations can include the pattern recognition engine 130b within a separate system, as well as within as part of the application 110's inherent functionality. Thus, while illustrated as a single component in the example environment 100 of FIG. 1, alternative implementations may illustrate the ERP system 103 as comprising multiple parts or portions, accordingly.

FIG. 1 depicts a server-client environment, but could also represent a cloud computing network. Various other implementations of the illustrated environment 100 can be provided to allow for increased flexibility in the underlying system, including multiple ERP systems 103 performing or executing one or more additional or alternative instances of the pattern recognition engine 130b for one or more different platforms, as well as multiple instances of the application 110 and its related functionality. In those instances, the different ERP systems 103 may communicate with each other via a cloud-based network or through the connections provided by network 148.

The interface 106, similar to the interfaces 108a and 108b, is used by the ERP system 103 to communicate with other systems in a client-server or other distributed environment (including within environment 100) connected to the network 148 (e.g., one of the sellers/customers 170, as well as other systems communicably coupled to the network 148). The interface 106 generally includes logic encoded in software and/or hardware in a suitable combination and operable to communicate with the network 148. More specifically, the interface 106 may include software supporting one or more communication protocols associated with communications such that the network 148 or the interface's hardware is operable to communicate physical signals within and outside of the illustrated environment 100.

Generally, the ERP system 103 may be communicably coupled with a network 148 that facilitates wireless or wireline communications between the components of the environment 100 (i.e., between the ERP system 103 and one or more sellers/customers 170), as well as with any other local or remote computer, such as additional clients, servers, or other devices communicably coupled to network 148, including those not illustrated in FIG. 1. In the illustrated environment, the network 148 is depicted as a single network, but may be included of more than one network without departing from the scope of this disclosure, so long as at least a portion of the network 148 may facilitate communications between senders and recipients. In some instances, one or more of the components associated with the ERP system 103 may be included within the network 148 as one or more cloud-based services or operations.

The network 148 may be all or a portion of an enterprise or secured network, while in another instance, at least a portion of the network 148 may represent a connection to the Internet. In the illustrated example, at least a portion of the network 148 includes a portion of a cellular or mobile data network or other network capable of relaying SMS messages. In some instances, a portion of the network 148 may be a virtual private network (VPN). Further, all or a portion of the network 148 can include either a wireline or wireless link. Example wireless links may include 802.11/b/g/n, 802.20, WiMax®, and/or any other appropriate wireless link. In other words, the network 148 encompasses any internal or external network, networks, sub-network, or combination thereof operable to facilitate communications between various computing components inside and outside the illustrated environment 100. The network 148 may communicate, for example, Internet Protocol (IP) packets, Frame Relay frames, Asynchronous Transfer Mode (ATM) cells, voice, video, data, and other suitable information between network addresses. The network 148 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the ERP system 103 includes a processor 109. Although illustrated as a single processor 109 in the ERP system 103, two or more processors may be used in the ERP system 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the ERP system 103 and, specifically, the functionality associated with the corresponding application 110 and the pattern recognition engine 130b. In one implementation, the server's processor 109 executes the functionality required to receive and respond to requests and instructions from the seller/customer 170, as well as the functionality required to perform the operations of the associated application 110 and the pattern recognition engine 130b, among others.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java®, Visual Basic, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding pattern recognition engine 130b and the application 110 stored on the associated ERP system 103. In some instances, a particular ERP system 103 may be associated with the execution of two or more applications 110 (and other related components), as well as one or more distributed applications executing across two or more servers executing the functionality associated with the ERP system 103.

At a high level, each ERP application 110 is any application, program, module, process, or other software that may execute, change, delete, generate, or otherwise manage information associated with a particular ERP system 103, and in some cases, a business process performing and executing business process-related events. In particular, business processes communicate with other users, applications, systems, and components to send, receive, and process events. In some instances, a particular ERP application 110 may operate in response to and in connection with one or more requests received from an associated seller/customer 170 or other remote client. Additionally, a particular ERP application 110 may operate in response to and/or in connection with one or more requests received from other ERP applications 110 external to the ERP system 103. In some instances, the ERP application 110 may request additional processing or information from an external system or application. In some instances, one of more of the ERP applications 110 may represent a web-based application accessed and be executed by remote sellers/customers 170 via the network 148 (e.g., through the Internet, or via one or more cloud-based services associated with the ERP application 110). Further, while illustrated as internal to the ERP system 103, one or more processes associated with a particular ERP application 110 may be stored, referenced, or executed remotely. For example, a portion of a particular ERP application 110 may be a web service that is remotely called, while another portion of the ERP application 110 may be an interface object or agent bundled for processing at a remote system (not illustrated), a particular seller/customer 170 (e.g., the client application 173). Moreover, any or all of a particular ERP application 110 may be a child or sub-module of another software module or enterprise application (not illustrated) without departing from the scope of this disclosure. Still further, portions of the particular ERP application 110 may be executed or accessed by a user working directly at the ERP system 103, as well as remotely at a corresponding seller/customer 170.

The pattern recognition engine 130b, similar to the pattern recognition engine 130a of the seller/customer 170, may include various pattern recognition modules similar to the adaptive pattern module 133, the contextual pattern module 136 and the generic pattern module 139. The execution preference between the pattern recognition engine 130b and 130a can be determined by the least computation resource spending on loading records and rules to achieve an efficient operation. For example, some patterns may be recognized using pattern recognition engine 130b when data is more related to the memory 112 than the memory 177, for example, matching data to existing records in the buyer information 118, the supplier information 121, the transaction record 123, and the adaptation record 125, among others. The recognized data can be written to the delivery notification data object 127b that can later be combined and synchronized with the delivery notification data 127a in the memory 177. In some implementations, only one, or more than one, pattern recognition engine 130 may be included within the environment 100.

The memory 112 of the illustrated ERP system 103 stores the purchase order database 115, buyer information 118, supplier information 121, transaction record 123, adaptation record 125, delivery notification data object 127b, and other data and program instructions, as well as metadata associated with pattern recognition engine 130b. The memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects, object models, and data, including classes, frameworks, applications, backup data, business objects, jobs, web pages, web page templates, database tables, process contexts, repositories storing services local to the ERP system 103, and any other appropriate information including any parameters, variables, algorithms, instructions, rules, constraints, or references thereto associated with the purposes of the ERP system 103 and its functionality. In some implementations, including a cloud-based system, some or all of the memory 112 may be stored remote from the ERP system 103, and communicably coupled to the ERP system 103 for usage. Specifically, memory 112 can store pattern recognition engine 130b. Some or all of the elements illustrated within memory 112 may be stored external to the memory 112. These items are made accessible to the pattern recognition engine 130b.

Returning to the seller/customer 170 illustrated in FIG. 1, the environment may include one or more sellers/customers 170. Each seller/customer 170 may be any computing device operable to connect to or communicate with at least one of the ERP system 103 using a wireline or wireless connection directly or via the network 148, or another suitable communication means or channel. In some instances, the seller/customer 170 may be a part of or associated with a business process involving one or more of the applications 110, or alternatively, a remote developer or user associated with the application 110, for example, the client application 173. It will be understood that there may be any number of sellers/customers 170 associated with, or external to, environment 100. For example, while illustrated environment 100 includes a seller/customer 170, alternative implementations of environment 100 may include multiple sellers or customers communicably coupled to the one or more of the systems illustrated. In some instances, one or more sellers/customers 170 may be associated with administrators of the environment, and may be capable of accessing and interacting with the settings and operations of the pattern recognition engines 130a and/or 130b, one or more applications 110, and/or other components of the illustrated environment 100. Additionally, there may also be one or more additional sellers/customers 170 external to the illustrated portion of environment 100 capable of interacting with the environment 100 via the network 148.

In addition, the illustrated environment 100 of FIG. 1 includes one or more suppliers/shippers. Each supplier/shipper 180 may be a computational device that can generate a shipment notification to the seller/customer 170 as items in a purchase order are shipped. The supplier/shipper 180 can physically produce and deliver the printed document 150 to the seller/customer 170, or the supplier/shipper 180 can generate and send web content 166 (e.g., a notification webpage, an email, etc.). The supplier and shipper 180 includes a processor 184, a memory 188, an interface 108b, a GUI 182 and a client application 186 for generating and sending the web content 166 to the network 148. On or more components of the supplier/shipper 180 can be similar to the components discussed above about the seller/customer 170. The web content 166 can be collected by the ERP system 103, and/or the seller/customer 170. In some applications, the web content 166 can be directly used as the text document 190 for detecting and extracting data for delivery notifications.

As used in this disclosure, each seller/customer 170 and supplier/shipper 180 is intended to encompass a personal computer, touch screen terminal, workstation, network computer, kiosk, wireless data port, smart phone, personal data assistant (PDA), one or more processors within these or other devices, or any other suitable processing device. For example, each seller/customer 170 may include a computer that includes an input device, such as a keypad, touch screen, mouse, or other device that can accept user information, and an output device that conveys information associated with the operation of one or more client applications 173, pattern recognition engine 130a, and/or the seller/customer 170 itself, including digital data, visual information, or the GUI 179. Both the input and output device may include fixed or removable storage media such as a magnetic storage media, CD-ROM, or other suitable media, to both receive input from and provide output to users of seller/customer 170 through the display, namely, the GUI 179. The client's processor 171 and 184, interfaces 108a and 108b, and memory 177 and 188 may be similar to or different from those described in connection with the other components illustrated in FIG. 1, although alternative implementations of one or more of these components may be used, as well as implementations where additional components may also be included.

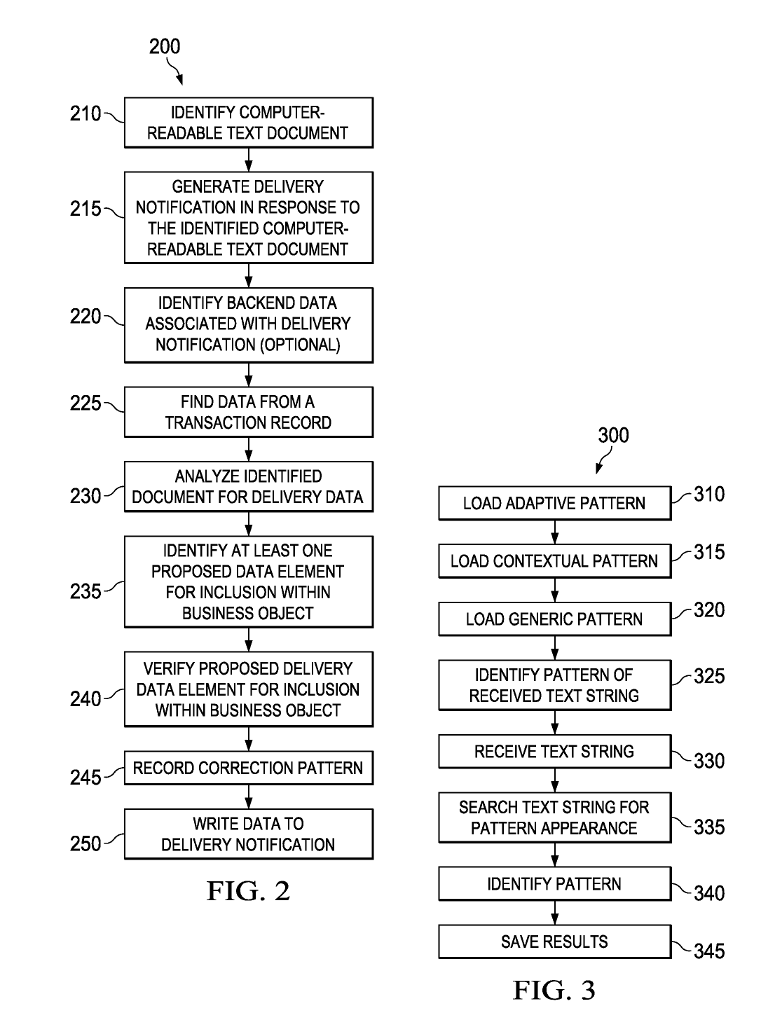

FIG. 2 is a flow chart illustrating a general process 200 of analyzing and digitizing delivery notifications. The general process 200 can be applied to the example environment 100. At 210, a computer-readable text document is identified, from a digital document or a converted physical document. For example, the computer-readable text document can be transmitted directly from a supplier or shipper via a network (e.g., the internet), or the computer-readable text document can be generated using OCR techniques over a scanned digital document from a physical, printed document. In many instances, the inbound document(s) associated with a shipment notification can be a printed document, such as a photocopy 151, a fax document 152, or a paper mail 154 described in FIG. 1. The printed document can be scanned using any photo detection devices, for example, a camera, a scanner, etc. at a certain resolution (e.g., 300 pixels per inch) to generate a digital image file (e.g., a JPEG file, a TIFF file, a PNG file, etc.). The digital image file can then be processed with any developed OCR techniques to convert the digital image into a text file, for example, in TXT format, PDF format, etc. In some implementations, the inbound document can also be included in web content, such as an email or a webpage.

At 215, a delivery notification associated with the identified computer readable text document is generated. The delivery notification can be a template for writing in delivery notification data object data. The template can be used to accept delivery notification data detected from the identified text document at 210 in the following steps. In some instances, the delivery notification may be associated with a new instance of a delivery notification data or business object, such as the delivery notification data object 127a described in FIG. 1.

At 220, backend data associated with delivery notification is identified. For example, a purchase order associated with the text document, or any appropriate predecessor document associated with the text document (e.g., a customer invoice, an outbound delivery or sales order, a stock transfer order, a service order, or a customer return), is identified from the detected information. In an example where a purchase order identified, for example, a matching purchase order (or other predecessor document) number between the transaction record stored in an ERP system and the text document may be identified. The purchase order or predecessor document may be initially identified by a pattern recognition method, such as by searching for the phrase “PO Number,” “Purchase Order Number,” “Purchase Order #,” or any other suitable text that may be included within the text document and appropriate for use in matching the predecessor document. For example, data nearby the identified phrase may be used to determine the purchase order, and used for further analysis. An example of the purchase order identification process is illustrated by the flow charts in FIGS. 4A and 4B. In some implementations, step 220 is optional. For example, there may not be a predecessor document associated with the text document, such as when the text document is new to the ERP system. In some other instances, more general backend data (i.e., master data, etc.) covering or associated with at least some information in the text document may be used to be associated with the text document and the populated business or data object.

Turning briefly to FIGS. 4A and 4B, flow charts illustrating, respectively, a high level and a low level purchase order identification process. In FIG. 4A, a high level logic flow chart 400 is shown. The start and end of the flow chart are illustrated at 401 and 440, respectively. The purchase order identification process starts at 405 where commands for finding purchase order id are initiated. If a positive return is received at 406, then the program continues to validate supplier at 411 and then to validate product table at 413. The supplier and the product table associated with the purchase order can be found in an associated ERP or other backend system, as well as any database storing information related to the transaction record of the purchase order. If a negative return is received at 406, supplier information is to be identified from the text document at 421. If the supplier information can be positively identified at 422, then the program continues to validate the purchase order identification number at 426 and to validate the product table at 427. If a negative return is received at 422, then an attempt to identify the product table at 431 is executed. All execution returns to and ends at 440.

FIG. 4B shows a detailed flow diagram 450 of identifying and validating the purchase order identification. The process starts at 451, where all patterns are loaded at 453. For example, patterns can be loaded from memory and be used for analyzing the document. For example, text strings of the text document can be analyzed for possible groups for pattern recognition. At 455, the possible groups of information are detected for purchase order matching. If a positive detection is returned at 456, where adaptive patterns are used for detecting the purchase order, then the process continues to 458, where predicted value and detected value are compared. If a positive comparison (i.e., data matching), then the process continues to a positive return code 480, signifying that the purchase order has been identified. If a negative comparison is found at 458, then the process continues to 460, converging with the same flow if adaptive pattern cannot identify the purchase order in the data object at 456.

At 460, contextual pattern recognition is used in search for the purchase order. If a positive detection is returned at 460, where contextual patterns are used for detecting the purchase order, then the process continues to 462, where predicted value and detected value are compared. If a positive comparison (i.e., data matching), then the process continues to a positive return code 480, signifying that the purchase order has been identified. If a negative comparison is found at 462, then the process continues to 464, converging with the same flow if contextual pattern cannot identify the purchase order in the data object at 460. At 464, generic pattern recognition is used in search for the purchase order. If a positive detection is returned at 464, where generic patterns are used for detecting the purchase order, then the process continues to 466, where predicted value and detected value are compared. If a positive comparison (i.e., data matching), then the process continues to a positive return code 480, signifying that the purchase order has been identified. If a negative comparison is found at 466, then the process continues to 470, converging with the same flow if contextual pattern cannot identify the purchase order in the data object at 464.

At 470, a reverse search for predicted value of the purchase order is performed. Within the reverse search, the text document is scanned for data matching using the set of relevant data from the ERP system. In case of reverse search for purchase orders, the list of relevant purchase order identification numbers from the ERP system is used for comparison. Text documents can be scanned for each purchase order ID from the list in a one by one fashion. If a positive match can be identified at 472, then then the process continues to a positive return code 480, signifying that the purchase order has been identified. If the reverse search cannot identify the predicted value of the purchase order at 472, a negative return code 475 is returned.

Returning to FIG. 2, after purchase order has been identified at 220 using, for example, methods similar to the examples shown in FIGS. 4A and 4B, data from the transaction record related to the purchase order are located at 225. The data can be accessed from the ERP system based on the identified purchase order from the related transaction record. In one example, a query, using the purchase order as a basis, can be used to request and retrieve related information from the ERP server and purchase order-related data, such as transaction records, receipts, and other suitable information. For example, the data can include buyer information (e.g., address, phone number, billing information, etc.), seller information, purchased items, quantity, etc. The data can be used to assist the detection process of the text document. For example, there may be a situation where pattern recognition cannot correctly identify information related to a purchase order, but a reverse search using the data from the transaction record can relate the text document to a purchase order. The data may also be used to verify information detected using pattern recognition from the text document, as the stored data are independent from the identified text file at 210. For example, the data related to the identified transaction record can provide a verification reference such as total ordered quantity, buyer information (e.g., shipping address, phone numbers, fax numbers, emails, among others). In some instances, some data associated with the transaction record may not be included within the text document, such that the data from the backend or ERP system can supplement that included within the text document.

At 230, the identified text document is analyzed for delivery data using an information recognition method to identify a proposed set of information associated with the purchase order identified at 220. In some implementations, the information recognition method can be illustrated using the flow chart as shown in FIG. 3. Turning briefly to FIG. 3, FIG. 3 is a flow chart illustrating an example pattern recognition process 300 used in analyzing and digitizing delivery notifications. The pattern recognition process 300 starts by loading various recognition patterns. For example, at 310, adaptive patterns are loaded for adaptive pattern recognition, which, for example, may be executed at a module similar to the adaptive pattern module 133 discussed in FIG. 1. At 315, contextual patterns are loaded for contextual pattern recognition, which may be executed at a module similar to the contextual pattern module 136 discussed in FIG. 1. At 320, generic patterns are loaded for generic pattern recognition, which, for example, may be executed at a module similar to the generic pattern module 139 discussed in FIG. 1. At 330, a text string of the text document (e.g., identified at 210 in FIG. 2) is received. The text string is then searched for pattern appearance using the loaded patterns at 335. The pattern is then identified at 340 and the results are saved at 345.

Returning to FIG. 2, at least one proposed data element is identified for inclusion within a delivery notification data object at 235. For example, the data object can include various information including a purchase order ID, a delivery notification ID, a shipping date, time, or time zone, a planned delivery date, time, or time zone, a gross weight, a gross volume, an incoterms code, an incoterms location, a sender ID, a sender name, a sender address, a ship to party ID or name, a ship to party address, a freight forwarder ID or name, a tracking ID, a tracking URL, a line item ID, a purchase order item ID, a product ID, a delivery notification quantity and a quantity unit, among others. The data element for the delivery notification data objects may use specific pattern recognition methods. For example, gross weight may be detected using contextual recognition by key words such as “gross weight” and/or weight units (e.g., kg, lb., ton, etc.). Gross weight may also be detected using an adaptive pattern adapted from the original contextual pattern, for example, when differentiation from item weight is required or by field context. Generic pattern recognition may be helpful in determining incoterms code, shipment date, time or time zone, and other common data fields. In some implementations, such as for identifying sender name for inclusion within the data object, a reverse search may be used. The reverse search can be helpful for limiting the number of possible purchase orders to be identified with the text string.

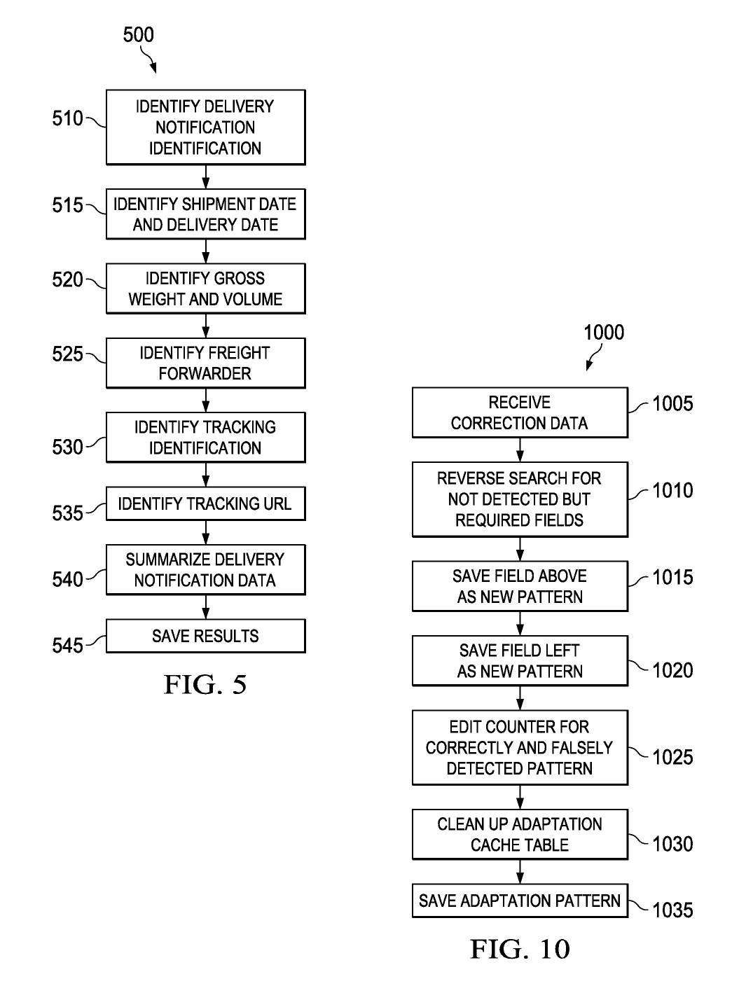

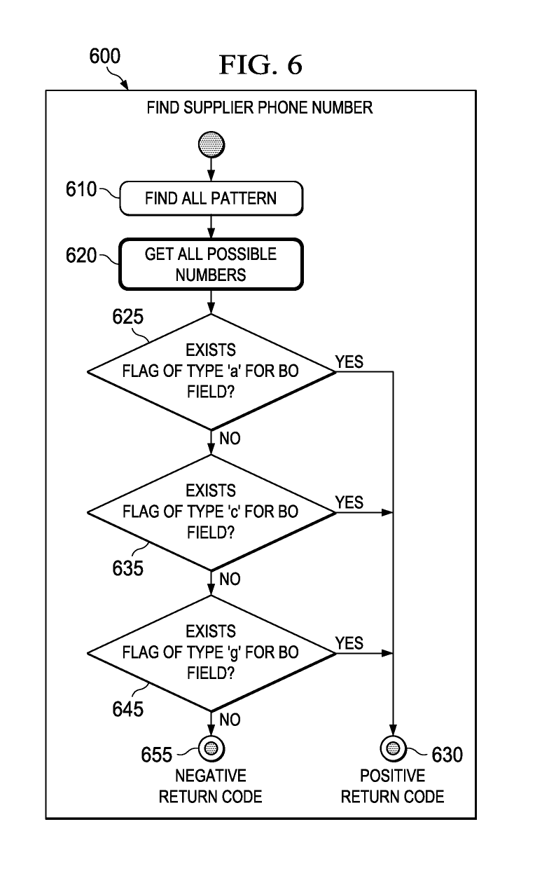

In some implementations, the proposed data element identification process can be tailored to specifically extract data fields related to delivery notification. For example, FIG. 5 shows an example process for identifying data fields most pertinent to delivery notifications. FIG. 5 is a flow chart illustrating a process 500 for identifying key information in a delivery notification. The delivery notification ID is first identified at 510. Shipment date and delivery data are then identified at 515. Gross weight and volume are identified at 520. The freight forwarder or carrier is identified at 525. Tracking ID and tracking URL are respectively identified at 530 and 535. Then, overall delivery notification data is summarized at 540 and the results are saved at 545. Although the data fields are identified in a certain order described above, there can be, in some implementations, different sequences or including additional or fewer steps. The identification process of delivery notification ID, shipment date and delivery date, tracking ID and URL may be illustrated in the flow chart shown in FIG. 6.

FIG. 6 is an example flow chart 600 illustrating pattern recognition used in identifying key information. When analyzing the text document (e.g., identified at 120 in FIG. 1), patterns are first loaded at 610. All numbers in the text document are then detected at 620. At 625, adaptive pattern recognition is applied to the numbers. If a particular adaptive pattern is detected and available for use, a positive return code 630 is sent; otherwise the process continues to a contextual recognition at 635. If a particular contextual pattern is detected and available for use, a positive return code 630 is sent; otherwise the process continues to a generic recognition at 645. If a particular generic pattern is detected, a positive return code 630 is sent; otherwise a negative return code 655 is sent.

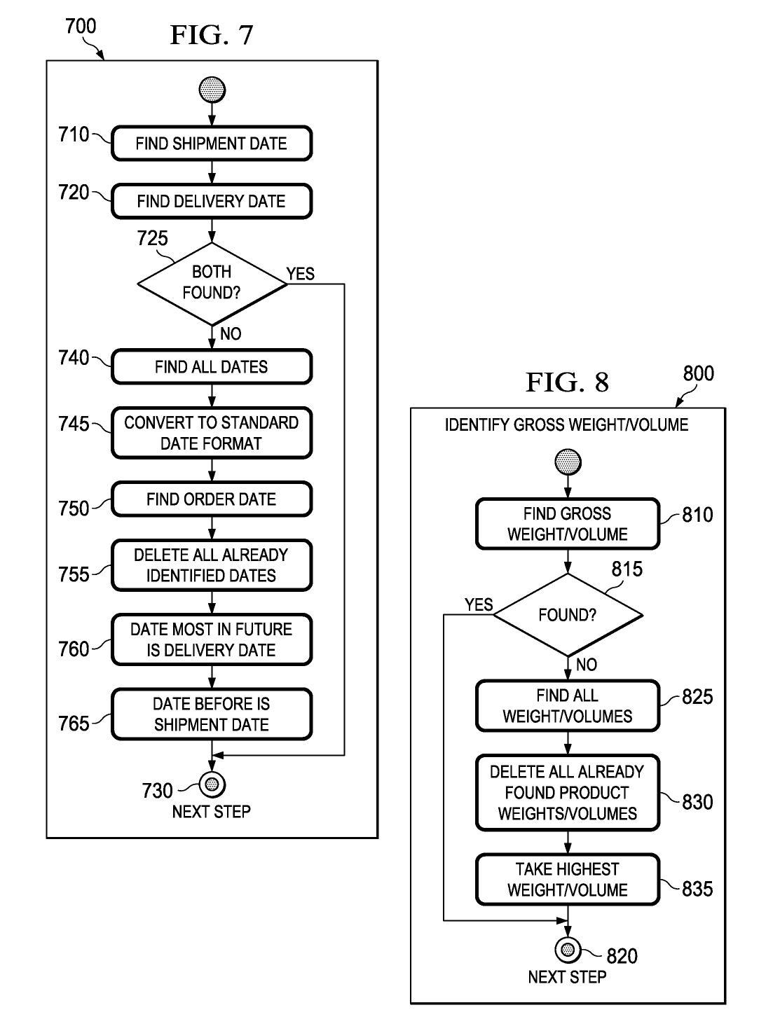

For identifying shipment date and delivery date, a different process may be utilized. FIG. 7 is a flow chart illustrating a process 700 for identifying shipment date and delivery date. At 710 and 720, processes are initiated for finding shipment date and delivery date. If both are found at 725, a positive return code 730 is sent to continue with a next step; otherwise the process continues to 740 for identifying all dates in various possible formats. For example, the date of January the second, 2001 may be in the formats of: 2001.1.2, 1/2/2001, 2/1/2001, Jan. 2^{nd}, 2001, among others. Once all the dates are identified, they are converted into standard date format at 745. The order date, based on context information, is then identified at 750. In some implementations, a reverse search may be performed based on existing transaction record stored in database. At 755, the dates that have already been identified are removed from the dates that are being analyzed. With the remaining dates, the date that is farthest in future is determined to be the delivery date at 760. The closest date in history before the delivery date is then determined to be shipment date at 765. As the dates have been identified, a positive return code 730 is sent to continue with the next step. As with any of the determinations, users may have the opportunity to compare the information detected by process 700 to a visual representation delivery notification as received.

For identifying gross weight or volume, a specific process may be applied. FIG. 8 is a flow chart illustrating a process 800 for identifying gross weight and volume of shipment. At 810, process 800 is initiated to find gross weight or volume. If the data can be correctly identified at 815, a positive return code 820 is sent to continue with the next step; otherwise the process continues to 825 where all weight and volume information is identified (e.g., based on numbers and units). At 830, identified product weights and volumes are deleted. With the remaining numbers, the highest weight or volume is determined to be the gross weight or volume at 835. As the gross weight and volume are identified, a positive return code 820 is sent to continue with the next step.

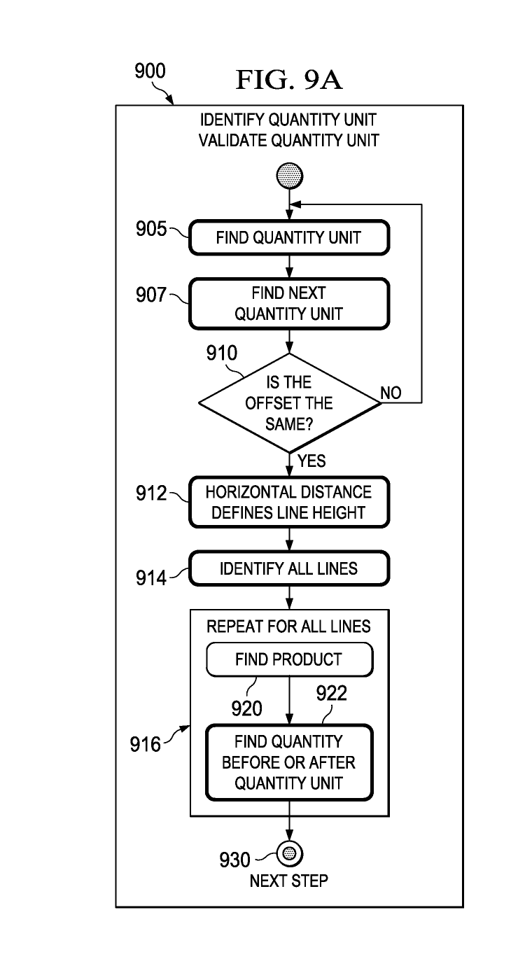

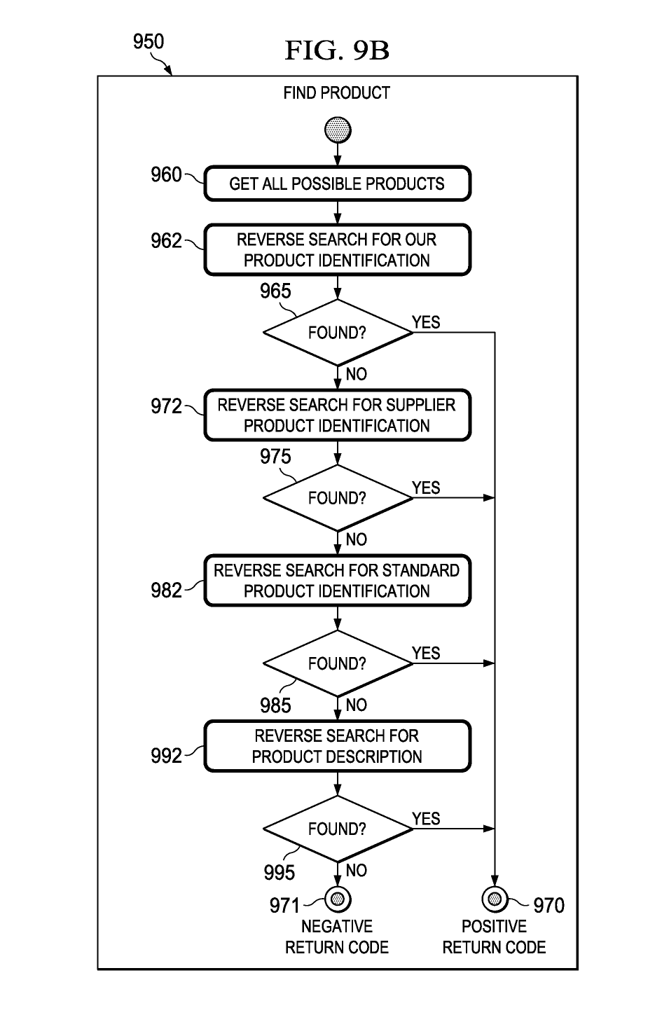

For identifying and validating quantity unit and finding products, specific methods or processes can be used. FIGS. 9A and 9B are example flow charts illustrating different identification processes. First referring to FIG. 9A, a process 900 for identifying and validating quantity unit is shown. At 905, identification of quantify unit is initiated. At 907, next quantity unit is identified. At 910, comparison is performed to identify if the offset between the two units are the same. If they are not the same, the process 900 returns to 905; if they are the same, the process 900 continues to 912 where line height is determined using horizontal distances. At 914, all lines are identified. At 916, all lines are repeated for searching the product at 920 and for determining the quantity before or after the quantity unit at 922. A positive return code 930 is sent to continue with the next step.

FIG. 9B illustrates a process 950 for finding products in the text document. At 960, all possible product names are identified. At 962, a reverse search is performed for the product ID that matches with the identified product. If a positive match is found at 965, a positive return code 970 is sent to continue with the next step; otherwise a reverse search for supplier product ID is performed at 972. If a positive match is found at 975, a positive return code 970 is sent to continue with the next step; otherwise a reverse search for standard product ID is performed at 982. If a positive match is found at 985, a positive return code 970 is sent to continue with the next step; otherwise a reverse search for product description is performed at 992. If a positive match is found at 995, a positive return code 970 is sent to continue with the next step; otherwise a negative return code 971 is sent to continue with the next step.

Returning to FIG. 2, at 240, the proposed delivery data element for inclusion within the delivery notification data object is verified. For example, the proposed delivery data can be examined by a user or customer who receives the identified text document, such as the seller/customer 170 of FIG. 1. The user or customer can compare the original incoming text document with the identified data element to determine if any correction is needed. A confirmation can be made by the user or customer for the data element, or an updated data element can be input by the user or customer. If the data element is updated by the user, then the updated result is then recorded at 245 and saved as a new recognition pattern. In some implementations, the adapted new recognition pattern can be generated using a process illustrated in FIG. 10.

FIG. 10 is a flow chart illustrating an adaptation process 1000. The adaptation process 1000 starts at 1005 where correction data from a user reviewing the automatically detected data is received. To generate the adaptive recognition pattern, a reverse search is conducted for the non-detected but required fields at 1010. At 1015 and 1020, these fields are saved as new patterns. At 1015, fields above are saved; while at 1025, fields left are saved. At 1025, counters are edited for both correctly and falsely detected patterns (e.g., counting the number of correct recognitions and false recognitions as determined by the user's correction or non-correction of data). In some instances, if a large number of false recognitions are counted over time for a specific rule, that rule may be discarded as incorrect or insufficient. At 1030, an adaptation cache table that stores new patterns and counters is cleaned for receiving future patterns; and the adaptation pattern is saved at 1035 as the end of the adaptation process 1000. The saved adaptation recognition pattern may be used for future incoming text documents of similar properties (e.g., from the same sender or shipper).

At 250, the confirmed or updated data element is written to the delivery notification data object instance generated at 215. The updated delivery notification data object instance may be sent to buyers, customers, or saved locally as a record.

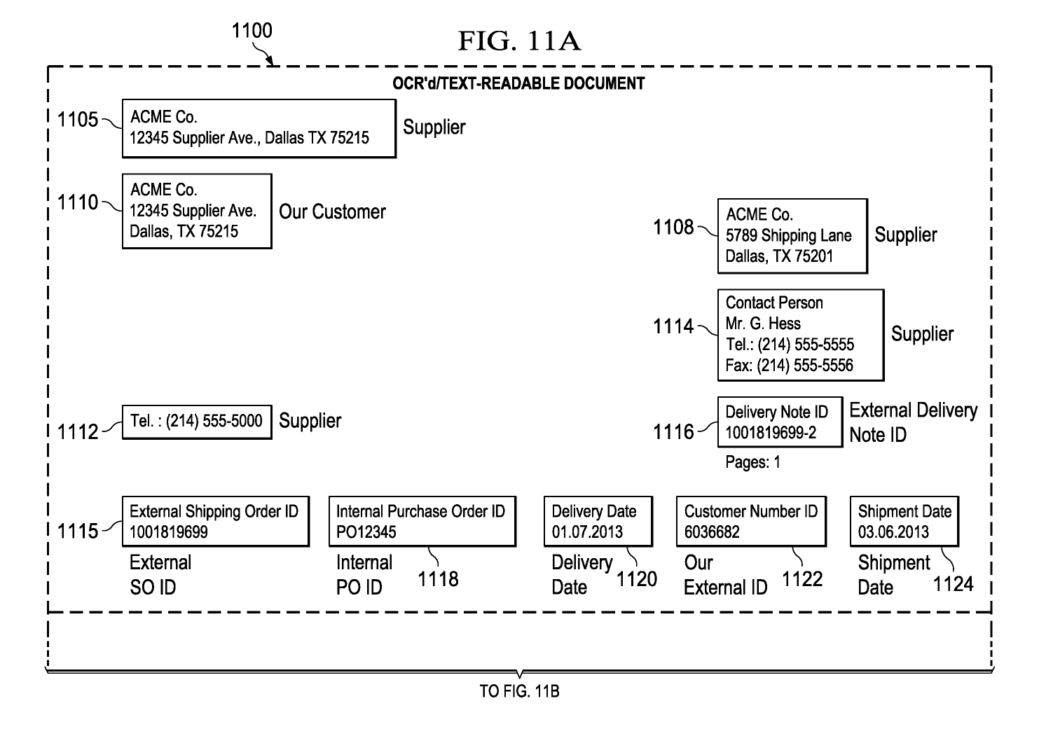

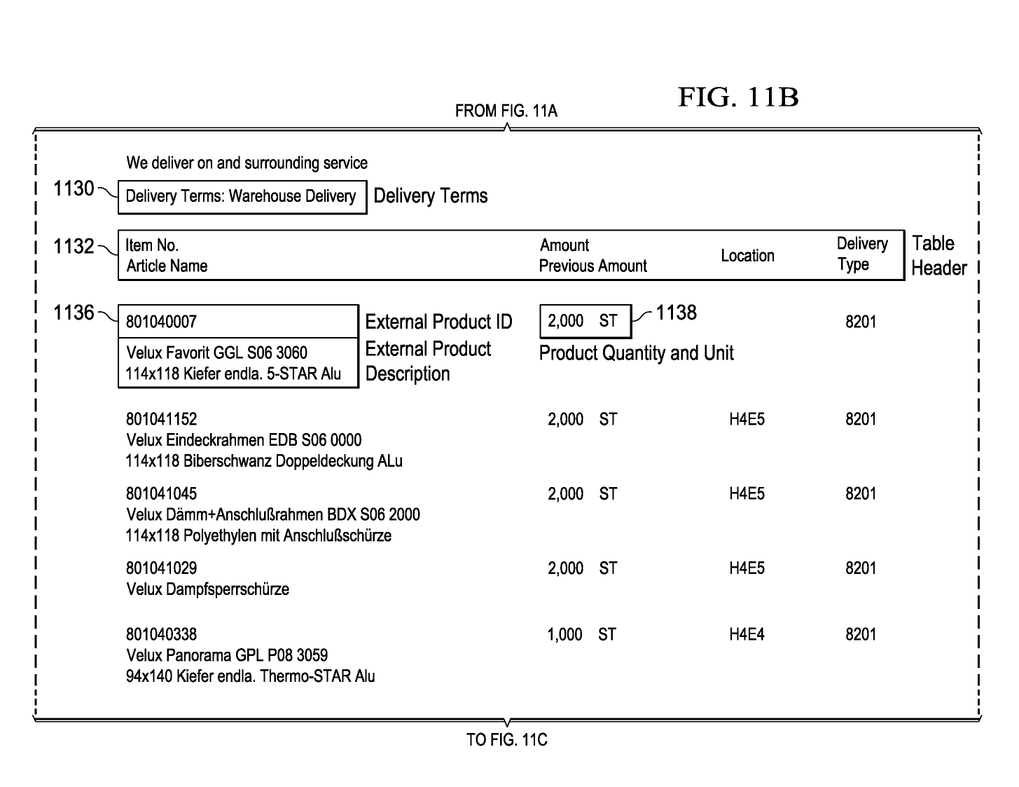

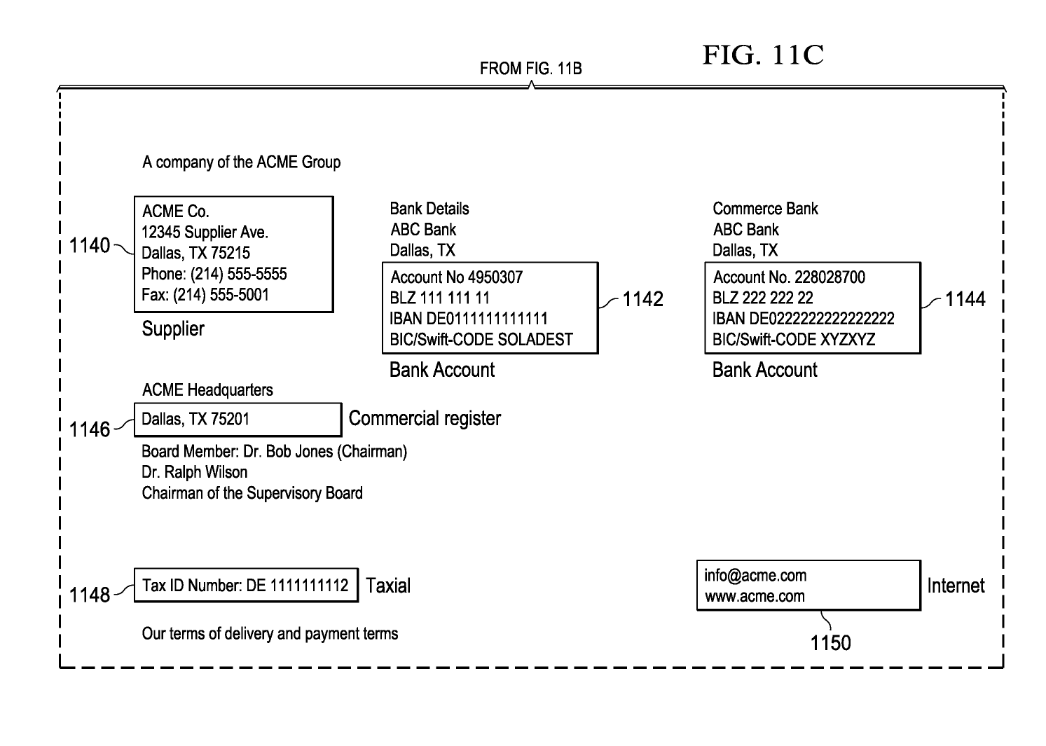

FIGS. 11A, 11B, and 11C show an example of delivery notification 1100. Referring first to FIG. 11A, the delivery notification 1100 can include an address of the supplier 1105, an address of the customer 1110, a different address of the supplier 1108 (e.g., located at different locations in the page due to different formats), contact information of the supplier 1114, telephone number 1112 of the supplier, external delivery note ID 1116, external shipping order ID 1115, internal purchase order ID 1118, delivery date 1120, external ID 1122, and shipment date 1124. This information may be arranged in a way similar to or different from the illustration of FIG. 11A based on specific suppliers or customers. The information may be presented without any prompted specification and the text document may rely on a pattern recognition engine such as the engines 130a and 103b as shown in FIG. 1.

FIG. 11B shows the next portion of the delivery notification 1100. In FIG. 11B, the delivery terms 1130, table header 1132, external product ID and description 1136, and product quantity and unit 1138 are shown. Similarly, FIG. 11C shows further information of the delivery notification 1100. In FIG. 11C, the supplier contact information 1140, a first bank account 1142, a second bank account 1144, a commercial register 1146, tax information 1148, and internet information 1150 are shown. The information illustrated in FIGS. 11A, 11B, and 11C can be analyzed, detected, and written into delivery notification data objects using the process 200 described in FIG. 2.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method for automatically generating at least a portion of a delivery notification record, the method comprising:
identifying a computer-readable text file associated with an inbound delivery notification at a first system, the first system associated with an enterprise resource planning (ERP) system;
identifying backend information associated with the identified text file from the ERP system;
analyzing the identified text file using an information recognition method to identify a proposed set of information associated with the identified backend information based on the analysis;
verifying at least a portion of the proposed set of information from the identified text file based on data associated with the ERP system and related to the identified backend information; and
associating at least a portion of the verified set of information from the identified text file with an instance of a delivery notification data object.

2. The method of claim 1, wherein the computer-readable text file is associated with an original document comprising an email, faxed document, scanned document, or paper document associated with the inbound delivery notification, and where the computer-readable text file represents a version of the original document analyzed using an optical character recognition technique.

3. The method of claim 1, wherein at least a portion of the ERP system data is associated with the delivery notification data object based on the association with the identified backend information.

4. The method of claim 1, wherein the backend information comprises a predecessor document associated with the identified text file.

5. The method of claim 4, wherein the predecessor document comprises a purchase order, a customer invoice, an outbound delivery or sales order, a stock transfer order, a service order, or a customer return.

6. The method of claim 1, wherein analyzing the identified text file using the information recognition method to identify at least a portion of a proposed set of information associated with the identified backend information comprises:
loading a set of pattern recognition rules;
searching the identified text file for at least one text string matching the at least one rule within set of pattern recognition rules; and
identifying at least one text string as at least a proposed set of information based on the pattern recognition rules.

7. The method of claim 6, wherein the set of pattern recognition rules further comprises a set of adaptive recognition rules, the set of adaptive recognition rules generated in response to analysis confirmation and correction feedback.

8. The method of claim 7, wherein the set of adaptive recognition rules are specific to a particular entity associated with the identified backend information or the delivery notification.

9. The method of claim 7, further comprising:
receiving at least one modification from the user via the user interface,
identifying a location of the at least one modification from the user based on a prior pattern match, and
saving the identified location and the related modification as an adaptive rule.

10. The method of claim 9, wherein the adaptive rule is revisable based on further user modification.

11. The method of claim 10, wherein the new pattern further comprises updating an existing pattern in response to receiving the at least one modification from the user.

12. The method of claim 7, wherein the set of adaptive recognition rules are specific to and associated with a particular supplier associated with the identified backend information.

13. The method of claim 5, wherein the set of pattern recognition rules comprises a set of generic rules, a set of contextual rules, and a set of adaptive rules.

14. The method of claim 1, further comprising presenting at least a portion of the verified set of information to a user interface associated with a user.

15. The method of claim 1, wherein the data associated with the ERP system and related to the identified backend information includes a transaction record associated with the identified backend information.

16. A computer program product comprising computer-readable instructions embodied on tangible, non-transient media, the computer program product operable when executed to:
identify a computer-readable text file associated with an inbound delivery notification at a first system, the first system associated with an enterprise resource planning (ERP) system;
identify backend information associated with the identified text file from the ERP system;
analyze the identified text file using an information recognition method to identify a proposed set of information associated with the identified backend information based on the analysis;
verify at least a portion of the proposed set of information from the identified text file based on data associated with the ERP system and related to the identified backend information; and
associate at least a portion of the verified set of information from the identified text file with an instance of a delivery notification data object.

17. The product of claim 16, wherein the computer-readable text file is associated with an original document comprising an email, faxed document, scanned document, or paper document associated with the inbound delivery notification, and where the computer-readable text file represents a version of the original document analyzed using an optical character recognition technique.

18. The product of claim 16, wherein at least a portion of the ERP system data is associated with the delivery notification data object based on the association with the identified backend information.

19. The product of claim 16, wherein analyzing the identified text file using the information recognition method to identify at least a portion of a proposed set of information associated with the identified backend information comprises:
loading a set of pattern recognition rules;
searching the identified text file for at least one text string matching the at least one rule within set of pattern recognition rules; and
identifying at least one text string as at least a proposed set of information based on the pattern recognition rules.

20. The product of claim 19, wherein the set of pattern recognition rules further comprises a set of adaptive recognition rules, the set of adaptive recognition rules generated in response to analysis confirmation and correction feedback.

21. The product claim 20, wherein the set of adaptive recognition rules are specific to a particular entity associated with the identified backend information or the delivery notification.

22. The product of claim 7, further operable when executed to:
receive at least one modification from the user via the user interface,
identify a location of the at least one modification from the user based on a prior pattern match, and
save the identified location and the related modification as an adaptive rule.

23. A system comprising:
one or more computers; and
a computer-readable medium coupled to the one or more computers having instructions stored thereon which, when executed by the one or more computers, cause the one or more computers to perform operations comprising:
identifying a computer-readable text file associated with an inbound delivery notification at a first system, the first system associated with an enterprise resource planning (ERP) system;
identifying backend information associated with the identified text file from the ERP system;
analyzing the identified text file using an information recognition method to identify a proposed set of information associated with the identified backend information based on the analysis;
verifying at least a portion of the proposed set of information from the identified text file based on data associated with the ERP system and related to the identified backend information; and
associating at least a portion of the verified set of information from the identified text file with an instance of a delivery notification data object.
